(19) United States
(12) Patent Application Publication
(10) Pub. No.: US 2019/0149970 A1
(43) Pub. Date: May 16, 2019

(54) INFORMATION PROCESSING APPARATUS, RECORDING MEDIUM, AND INFORMATION EXCHANGE METHOD

(71) Applicants: KABUSHIKI KAISHA TOSHIBA, Tokyo (JP); TOSHIBA TEC KABUSHIKI KAISHA, Tokyo (JP)

(72) Inventor: Toshiki Takeishi, Mishima Shizuoka (JP)

(21) Appl. No.: 16/244,171

(22) Filed: Jan. 10, 2019

Related U.S. Application Data
(63) Continuation of application No. 15/713,911, filed on Sep. 25, 2017.

(51) Int. Cl. H04W 4/80; H04M 1/725

(52) U.S. Cl. CPC H04W 4/80; G06F 21/35; H04M 1/7253

(57) ABSTRACT

According to an embodiment, an information processing apparatus includes a non-contact communication device and a processor. The non-contact communication device performs non-contact communication in a reader mode or a card mode. The processor switches the non-contact communication device to the card mode when transmission request information is set in an electronic message received by the non-contact communication device in the reader mode from a second non-contact communication device, and causes the non-contact communication device that is switched to the card mode to transmit an electronic message including information requested in the transmission request information to the second non-contact communication device.

### CROSS-REFERENCE TO RELATED APPLICATIONS

This application is a Continuation of application Ser. No. 15/713,911 filed on Sep. 25, 2017, the entire contents of which are incorporated herein by reference.

### FIELD

Embodiments described herein relate generally to an information processing apparatus, a recording medium, and an information exchange method.

### BACKGROUND

Some information processing apparatuses, such as a digital multi-function peripheral, a settlement apparatus (POS terminal) or an information distribution apparatus, are equipped with devices that perform non-contact communication. The non-contact communication is one in which two non-contact communication devices wirelessly communicate in close proximity (an area of about several centimeters). As non-contact communication, for example, a communication method called near field communication (NFC) is known. Non-contact communication is often operated as a technology for reading information from a non-contact IC card or a portable electronic device (mobile terminal). For example, an NFC terminal provided in an information processing apparatus such as a digital multi-function peripheral is used to read information such as authentication information from a non-contact IC card or a mobile terminal.

However, the NFC terminal mounted in an information processing apparatus in the related art usually functions as a card reader for reading information from a portable terminal. The card reader does not function as an interface for supplying a large amount of data to the mobile terminal at high speed. Therefore, there is a problem that communication control for acquiring data from the information processing apparatus becomes complicated even for a mobile terminal that may communicate with the information processing apparatus with NFC.

### DESCRIPTION OF THE DRAWINGS

FIG. 1 is a block diagram showing a configuration example of a digital multi-function peripheral as an information processing apparatus according to an embodiment.

FIG. 2 is a block diagram showing a configuration example of a mobile terminal according to the embodiment.

FIG. 3 is a sequence diagram for explaining a flow of information exchange processing between the digital multi-function peripheral and the mobile terminal.

FIG. 4 is a flowchart for explaining an operation example of the digital multi-function peripheral.

FIG. 5 is a flowchart for explaining an operation example of the mobile terminal.

### DETAILED DESCRIPTION

In order to solve the above-mentioned problem, an exemplary embodiment aims to provide an information processing apparatus, a recording medium, and an information exchange method capable of performing highly convenient information communication.

According to an embodiment, the information processing apparatus includes a non-contact communication device and a processor. The non-contact communication device performs non-contact communication in a reader mode or a card mode. The processor switches the non-contact communication device to the card mode when transmission request information is set in an electronic message received by the non-contact communication device in the reader mode from a second non-contact communication device, in which the non-contact communication device that is switched to the card mode transmits the electronic message including the information requested in the transmission request information to the second non-contact communication device.

Hereinafter, an embodiment will be described with reference to the drawings.

First, a communication system according to the embodiment will be described.

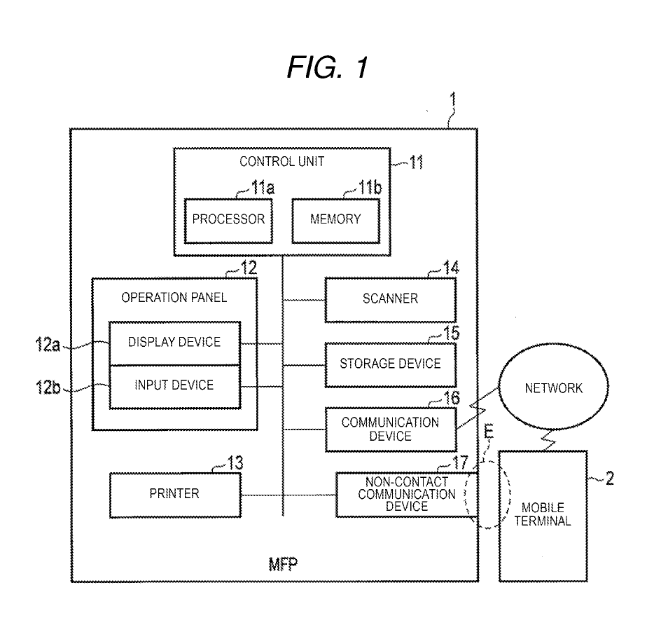

FIG. 1 is a block diagram showing a configuration example of the communication system including a digital multi-function peripheral (MFP) 1 as an information processing apparatus and the MFP 1 according to the embodiment.

The MFP 1 is an example of an information processing apparatus for exchanging information with a mobile terminal 2. The information processing apparatus is not limited to the MFP 1 but may be any apparatus that exchanges information with the mobile terminal 2. For example, the information processing apparatus may be a settlement apparatus (POS terminal) that performs settlement processing of products or an information distribution apparatus (kiosk terminal) that distributes information.

However, in the present embodiment, it is assumed that the information processing apparatus is the MFP 1. The MFP 1 is an image processing apparatus (a printing apparatus, an image reading apparatus, a copying apparatus, and the like) that performs image processing such as printing, scanning, and copying. The mobile terminal 2 is a portable electronic device (for example, a mobile phone, a smart phone, a tablet PC, and the like) possessed by a user.

In the present embodiment, the MFP 1 and the mobile terminal 2 have a function (first communication function) for performing non-contact communication for communicating in close proximity. The non-contact communication (near distance communication) may be any communication in close proximity (a narrow communication area of about several centimeters). Here, it is assumed that non-contact communication is a communication through a communication method that is applicable to a mobile terminal having a communication function equivalent to that of a non-contact type IC card or a non-contact type IC card. For example, as a communication method of non-contact communication, there is what is called near field communication (NFC). The non-contact communication may be communication by communication standards other than NFC, but in the present embodiment, it is assumed that non-contact communication is NFC.

In the present embodiment, it is assumed that a device (non-contact communication device) that performs non-contact communication operates in any one of the operation modes of a card emulation mode, a card reader mode (card reader/writer mode).

The card emulation mode (hereinafter, referred to as a card mode) is an operation mode in which the same operation as a non-contact type IC card (or a non-contact communication device equivalent to a non-contact type IC card) is performed.

Further, the card reader mode (hereinafter, referred to as a reader mode) is an operation mode for performing the same operation as the card reader for the non-contact type IC card. The reader mode is an operation mode in which information is read from a non-contact communication device (non-contact type IC card or card mode non-contact communication device) within the communication range of non-contact communication.

Further, the MFP 1 and the mobile terminal 2 also have a data communication function (second communication function) that transmits and receives data bi-directionally by a communication method different from non-contact communication. The data communication function between the MFP 1 and the mobile terminal 2 may be any communication as long as transmission and reception of data such as print data may be performed. In the present embodiment, it is assumed that the data communication function has a function of performing network communication for transmitting and receiving data via a network. Further, it is assumed that the network communication between the MFP 1 and the mobile terminal 2 is communication by a wireless LAN. However, the data communication function may be communication in a network including a wide area network (WAN) or may be another short-distance wireless communication different from non-contact communication.

Next, a configuration example of the MFP 1 as an information processing apparatus will be described.

As shown in FIG. 1, the MFP 1 includes a control unit 11, an operation panel 12, a printer 13, a scanner 14, a storage device 15, a communication device 16, and a non-contact communication device (NFC terminal) 17.

The control unit 11 includes a processor 11a and a memory 11b. The processor 11a is, for example, a central processing unit (CPU). The processor 11a is connected to each unit in the MFP 1 via a bus. The processor 11a executes an operation as the control unit 11 by executing a program stored in the memory 11b or the storage device 15. For example, the processor 11a executes the basic operation control of the MFP 1 by executing a program of an operating system (OS). In addition, the processor 11a executes various processing by executing an application program designed according to processing contents.

In addition, the memory 11b is constituted by a memory device such as a RAM and a ROM. For example, the ROM in the memory 11b stores various programs such as an OS program or an application program executed by the processor 11a. In addition, the RAM in the memory 11b is used, for example, as a work area for storing data to be temporarily used.

The storage device 15 is a rewritable nonvolatile memory. The storage device 15 consists of memory devices such as a hard disk drive (HDD), a solid state drive (SSD) or an electric erasable programmable read-only memory (EEPROM (registered trademark)), for example. The storage device 15 may store an OS or an application program. In addition, the storage device 15 stores data generated by processing executed by the processor 11a. In addition, the storage device 15 stores data to be used in various processing executed by the processor 11a.

The operation panel 12 includes a display device 12a and an input device 12b. The display device 12a displays information. The display device 12a is, for example, a display that consists of a liquid crystal display or an organic electro-luminescence (EL) display or the like. The input device 12b accepts an operation by a user (operator). The input device 12b is configured to include, for example, a touch panel, a keyboard, a numeric keypad, and the like. For example, the display device 12a and the input device 12b may consist of a display panel having a touch panel.

The printer 13 prints an image on a recording medium such as paper. The configuration of the printer 13 is not limited to a specific image forming method. For example, the printer 13 may be an electrophotographic method, an ink-jet method, or a thermal transfer method. In the present embodiment, it is assumed that the printer 13 is an electrophotographic type printer.

The scanner 14 reads the image of a document as image data. For example, the scanner 14 optically scans an image of a document to acquire image data. In this case, the scanner 14 includes an imaging element such as a charge-coupled device (CCD) image sensor and an optical system for guiding light from an original document to the imaging element. The scanner 14 may read images by other methods.

The communication device 16 is an interface for data communication. In the present embodiment, it is assumed that the communication device 16 is an interface for wirelessly communicating with the mobile terminal 2 via a network as a wireless LAN.

The non-contact communication device 17 is an interface for communication that performs non-contact communication. The non-contact communication device 17 is constituted by an antenna, a communication control circuit, and the like for short-distance wireless communication. The non-contact communication device 17 performs non-contact communication with another non-contact communication device in a connected state by electromagnetic coupling via the antenna. In the present embodiment, it is assumed that the non-contact communication device 17 performs non-contact communication with a non-contact communication device 27 of the mobile terminal 2 in a communication range E by NFC.

The non-contact communication device 17 operates in the operation modes of the card mode or the reader mode. The operation mode of the non-contact communication device 17 is switched under the control of the control unit 11. The non-contact communication device 17 is reactivated under the control of the control unit 11, whereby the operation mode is switched. For example, the non-contact communication device 17 in the reader mode is switched to the card mode by being reactivated under the control of the control unit 11.

Next, the configuration of the mobile terminal 2 will be described.

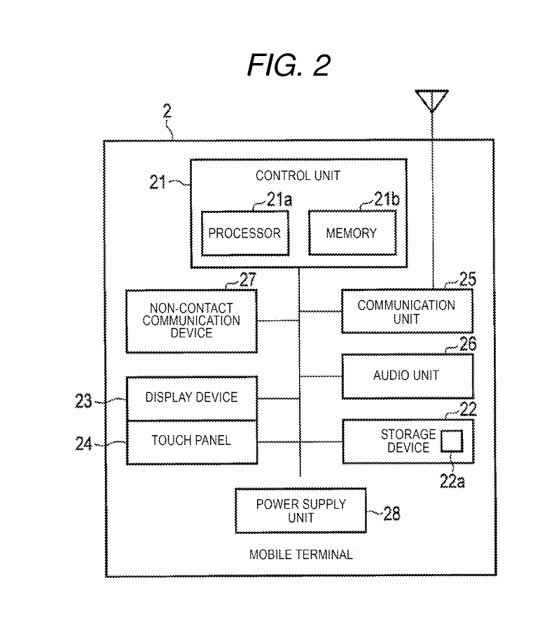

FIG. 2 is a block diagram showing a configuration example of the mobile terminal 2 according to the embodiment.

The mobile terminal 2 in the configuration example shown in FIG. 2 is a portable electronic device such as a smartphone, a tablet PC, a mobile phone, a PDA, or the like. As shown in FIG. 2, the mobile terminal 2 includes a control unit 21, a storage device 22, a display device 23, an input device 24, a communication unit 25, an audio unit 26, the non-contact communication device 27, a power supply unit 28, and the like.

The control unit 21 includes a processor 21a and a memory 21b. The processor 21a is, for example, a CPU. The processor 21a realizes various processing functions by executing a program. The memory 21b is constituted by a memory device such as a RAM and a ROM. For example, the ROM in the memory 21b stores various programs such as an OS program or an application program. In addition, the RAM in the memory 21b is used, for example, as a work area for storing data to be temporarily used.

The storage device 22 is a rewritable nonvolatile memory in which various data are stored. Various application programs (applications), control data, user data, and the like are stored in the nonvolatile memory 22. For example, the nonvolatile memory 22 stores an application to be downloaded via a network or the like by the user's operation. The processor 21a of the control unit 21 realizes various functions by executing the application programs stored in the storage device 22.

The display device 23 is constituted by a display device. In the display device 23, on and off of display and the contents of the display are controlled by the control unit 21. The input device 24 is constituted by a touch panel, a ten key, a keyboard, and the like. The input device 24 supplies an operation instruction input by the user to the control unit 21. For example, the display device 23 and the input device 24 are constituted by a display device with a touch panel.

The communication unit 25 is connected to the antenna and wirelessly communicates via the antenna. The communication unit 25 provides a communication function for the mobile terminal 2 to communicate with the MFP 1 via the network. For example, the communication unit 25 transmits print data to the MFP 1.

The audio unit 26 inputs and outputs audio. The audio unit 26 includes an analog front-end unit, an audio unit, and the like. A speaker, a receiver, a microphone, and the like are connected to the audio unit 26.

The power supply unit 28 is constituted by, for example, a rechargeable battery or the like. The power supply unit 28 supplies power to each unit in the mobile terminal 2.

The non-contact communication device 27 performs non-contact communication (short-distance wireless communication) with another non-contact communication device. The non-contact communication device 27 is constituted by an antenna for short-distance wireless communication and an IC chip for communication control and the like. The non-contact communication device 27 performs non-contact communication with another non-contact communication device in a connected state by electromagnetic coupling via the antenna. For example, the non-contact communication device 27 performs non-contact communication with the non-contact communication device 17 of the MFP 1.

The non-contact communication device 27 operates in the card mode or the reader mode. The non-contact communication device 27 operates in an operation mode set by the control unit 11. In the present embodiment, the non-contact communication device 27 operates to perform non-contact communication with the non-contact communication device 17 of the MFP 1. Therefore, the operation mode of the non-contact communication device 27 is switched according to the operation mode of the non-contact communication device 17 of the MFP 1. For example, when switching the non-contact communication device 17 from the reader mode to the card mode, the non-contact communication device 27 is switched from the card mode to the reader mode.

It is assumed that the non-contact communication device 27 is activated when presented in the communication range E and is stopped when separated from the communication range E. In the present embodiment, it is assumed that the non-contact communication device 27 needs to be reactivated in order to switch the operation mode. When the non-contact communication device 27 having such a specification is once separated from the communication range E and is presented to the communication range E again, it is possible to switch the operation mode by reactivation. For example, it is assumed that the non-contact communication device 27 in the card mode is switched to the reader mode by being presented again in the communication range E after once being separated from the communication range E.

In addition, the storage device 22 stores an application program (cooperative application for MFP) 22a for the mobile terminal 2 to operate in cooperation with the MFP 1. The processor 21a of the control unit 21 realizes the information exchange processing with the MFP 1, which will be described later, by executing the cooperative application for an MFP (hereinafter, simply referred to as a cooperative application) 22a. For example, the processor 21a loads the cooperative application 22a on the work memory (RAM) of the memory 21b. The processor 21a executes the information exchange processing using NFC with the MFP 1 by executing the cooperative application 22a loaded in the memory 21b.

Next, information exchange processing (communication control) between the MFP 1 and the mobile terminal 2 in the communication system will be briefly described.

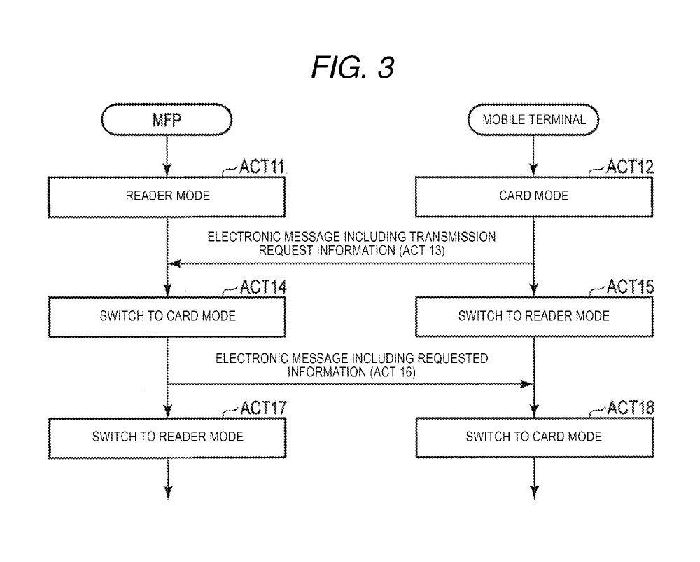

FIG. 3 is a sequence diagram schematically showing the flow of information exchange processing between the MFP 1 and the mobile terminal 2 in the communication system.

In a standby state, it is assumed that the non-contact communication device 17 of the MFP 1 waits in the reader mode (ACT 11). The MFP 1 waits in a state where the MFP 1 may receive the electronic message from the non-contact communication device in the card mode within the communication range E by the non-contact communication device 17 in the reader mode.

On the other hand, when the cooperative application 22a is activated, the mobile terminal 2 activates the non-contact communication device 27 in the card mode (ACT 12). When the mobile terminal 2 is held in the communication range E, the electronic message may be transmitted from the non-contact communication device 27 in the card mode to the non-contact communication device 17 in the reader mode.

In addition, the cooperative application 22a installed in the mobile terminal 2 realizes information exchange processing with the MFP 1 by non-contact communication and various processing request functions for the MFP 1. For example, the cooperative application 22a causes the mobile terminal 2 to realize information exchange processing for acquiring information from the MFP 1 by switching the card mode and the reader mode.

In information exchange processing, the mobile terminal 2 requests information from the MFP 1 by setting the transmission request information in tag information of information to be transmitted in the card mode (an electronic message to be transmitted to the MFP 1 in the reader mode). The transmission request information is information indicating that information is requested to the MFP 1 (a device in the reader mode). The transmission request information may be specific information set in a record of an electronic message or may be specific information (a character string) set in a card ID as identification information indicating a transmission source of the electronic message. Here, it is assumed that the transmission request information is specific information set in the tag information in the electronic message.

In addition, the information requested by the transmission request information is not limited to specific information but may be appropriately set according to the operation mode or the like. For example, the information requested by the transmission request information is connection information (for example, an IP address of the MFP 1) for transmitting a print job (print data) to the MFP 1 by data notification other than non-contact communication. In addition, the information requested by the transmission request information may be information for requesting status information indicating the state of the MFP 1 (for example, information on the availability of print processing, the remaining amount of toner or ink, information on a sheet set, and the like).

When the mobile terminal 2 in the card mode is presented in the communication range E, the mobile terminal 2 transmits the electronic message according to the radio waves from the MFP 1 in the reader mode. That is, when the mobile terminal 2 requesting information from the MFP 1 is presented in the communication range E (overlapped), the mobile terminal 2 transmits to the MFP 1 the electronic message in which the transmission request information is set in the tag information (ACT 13). On the other hand, the MFP 1 in the reader mode receives the electronic message in which the transmission request information is set as the tag information from the mobile terminal 2 in the card mode.

When the MFP 1 in the reader mode receives the electronic message in which the transmission request information is set, the MFP 1 switches the operation mode from the reader mode to the card mode (ACT 14). That is, when there is transmission request information in the received electronic message, the MFP 1 in the reader mode reactivates the non-contact communication device 17 and switches to the card mode.

After switching to the card mode, the MFP 1 transmits the electronic message including the requested information to the mobile terminal 2 in the reader mode. For example, when the connection information for connecting to the MFP 1 is requested, the MFP 1 transmits the electronic message including the connection information after switching to the card mode (to cause the mobile terminal 2 in the reader mode to read). Further, when the state information is requested, the MFP 1 transmits the electronic message including the state information after switching to the card mode (to cause the mobile terminal 2 in the reader mode to read).

After transmitting the electronic message in which the transmission request information is set in the card mode, when the mobile terminal 2 once goes away from the communication range E and is presented again in the communication range E, the mobile terminal 2 is switched to the reader mode (ACT 15). Upon switching to the reader mode, the mobile terminal 2 receives from the MFP 1 in the card mode the electronic message in which the information requested by the transmission request information is set (ACT 16).

After switching to the card mode and transmitting the requested electronic message, the MFP 1 switches to the reader mode and shifts to the normal operation mode (standby information) (ACT 17). In addition, the mobile terminal 2 extracts the information requested from the electronic message acquired from the MFP 1 in the reader mode. The mobile terminal 2 may perform processing based on the information extracted from the acquired electronic message.

For example, when acquiring the connection information (for example, connection information on the network) of the MFP 1, the mobile terminal 2 communicatively connects to the MFP 1 via the network based on the acquired connection information. The mobile terminal 2 communicatively connected to the MFP 1 via the network may request the MFP 1 to perform processing involving data communication of data with a large data amount. For example, the mobile terminal 2 may request the MFP 1 to perform print processing by transmitting print data (a print job) via the network.

In addition, it is assumed that the mobile terminal 2 in the reader mode ends the reader mode after acquiring the requested information from the MFP 1. The mobile terminal 2 that ended the reader mode makes the non-contact communication device 27 operable in the card mode (ACT 18).

As described above, the MFP 1 and the mobile terminal 2 may mutually exchange information by switching the reader mode and the card mode and communicating with each other by NFC, as necessary. In addition, the information exchange processing described above may be realized by presenting the mobile terminal in the communication range E and then presenting the mobile terminal again, and information exchange may be performed with a simple operation.

Next, the operation of the MFP 1 in the information exchange processing described above will be described.

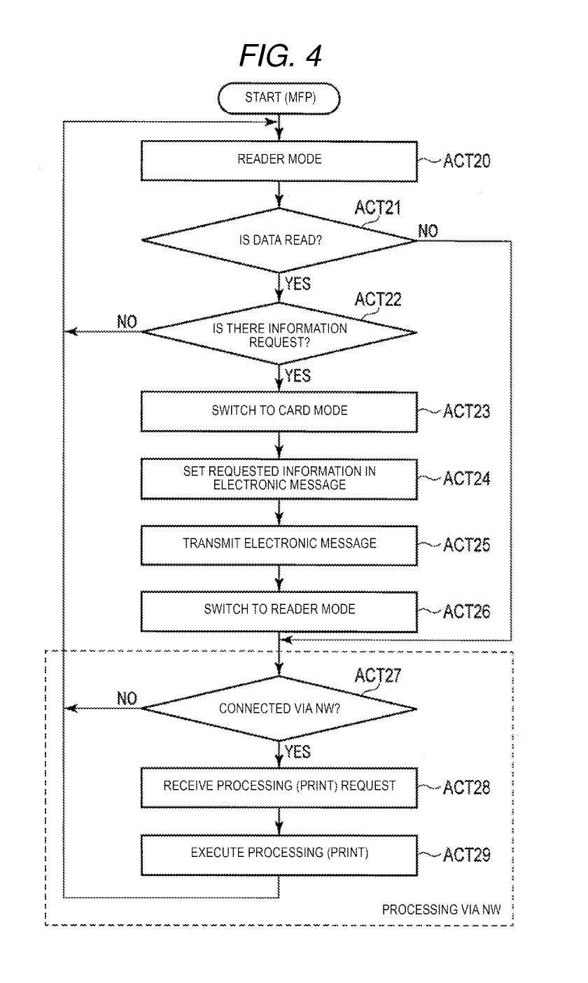

FIG. 4 is a flowchart for explaining an operation example of the MFP 1.

In the standby state, the non-contact communication device 17 of the MFP 1 waits in the reader mode (ACT 20). In the reader mode, the non-contact communication device 17 of the MFP 1 transmits the radio waves in the communication range E and receives the electronic message as a response from the non-contact communication device within the communication range E. When the non-contact communication device 27 of the mobile terminal 2 in the card mode enters the communication range E, the non-contact communication device 17 performs processing of reading information from the mobile terminal 2 (ACT 21). As the processing of reading information from the mobile terminal 2, the non-contact communication device 17 receives an electronic message (response electronic message) of a predetermined format from the mobile terminal 2.

The format of the electronic message received by the non-contact communication device 17 in the reader mode may be any format that conforms to the communication standard of NFC. Here, the electronic message includes the tag information that may set transmission request information for requesting information. The transmission request information requests the MFP 1 for information that the MFP 1 holds or generates. For example, the transmission request information may be request connection information for connecting to the MFP 1 via the network. In addition, the transmission request information may be information for requesting the status information of the MFP 1. In the operation example shown in FIG. 4, it is assumed that the transmission request information is information for requesting connection information for connecting to the MFP 1.

When receiving an electronic message by the non-contact communication device 17 (ACT 21, YES), the control unit 11 of the MFP 1 determines whether or not the transmission request information is set in the tag information of the received electronic message (ACT 22). When the transmission request information is set (ACT 22, YES), the control unit 11 switches the non-contact communication device 17 from the reader mode to the card mode (ACT 23). For example, the control unit 11 switches to the card mode by reactivating the non-contact communication device 17.

Further, when switching to the card mode, the control unit 11 sets the information requested in the transmission request information in the tag information of the electronic message output from the non-contact communication device 17 in the card mode (ACT 24). For example, when connection information is requested in the transmission request information, the control unit 11 sets the IP address or the like of the MFP as the connection information in the tag information of the electronic message. The non-contact communication device 17 that is switched to the card mode transmits the electronic message in which the requested information (connection information) is set according to the radio waves from the card reader (the mobile terminal 2 in the reader mode) (ACT 25). As a result, the non-contact communication device 17 of the MFP 1 may transmit the information (connection information) requested in the transmission request information to the mobile terminal 2 in the reader mode.

After transmitting the electronic message in which the requested information (connection information) is set, the control unit 11 switches the non-contact communication device 17 from the card mode to the reader mode (ACT 26). For example, the control unit 11 switches to the reader mode by reactivating the non-contact communication device 17. After switching the non-contact communication device 17 to the reader mode, the control unit 11 accepts communication by NFC in the reader mode as the standby state.

In addition, in the standby state, the control unit 11 also accepts communication connection via the network based on the connection information transmitted by the electronic message. In the example shown in FIG. 4, a flow of processing for executing printing based on a print job from the mobile terminal connected with the connection information after the MFP 1 transmits the connection information will be described.

When communicating with the mobile terminal 2 via the network according to the connection information transmitted by the electronic message (ACT 27, YES), the control unit 11 performs data communication with the mobile terminal 2. When communicatively connected to the mobile terminal 2, the control unit 11 accepts a processing request from the mobile terminal 2 (ACT 28). Upon receiving the processing request from the mobile terminal 2, the control unit 11 executes processing according to the request from the mobile terminal 2 (ACT 29). For example, the MFP 1 receives a print request (print job) including print data from the mobile terminal 2. Upon receiving the print job from the mobile terminal 2 communicatively connected according to the connection information, the control unit 11 executes print processing by the printer 13 according to the received indication of the print job.

Next, the operation of the mobile terminal 2 in information exchange processing will be described.

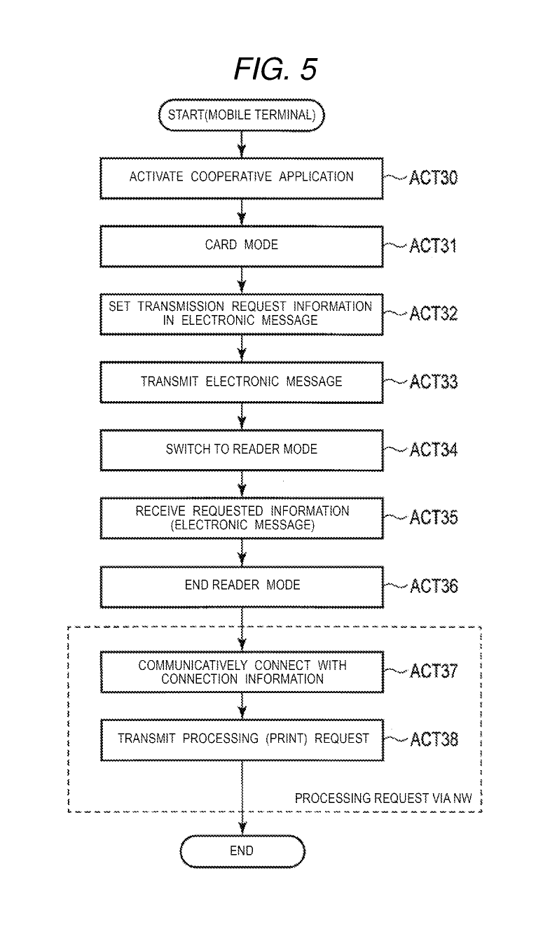

FIG. 5 is a flowchart for explaining an operation example of the mobile terminal 2.

The control unit 21 of the mobile terminal 2 activates the cooperative application 22a according to the user's operation (ACT 30). For example, when the user wants to print an image in the mobile terminal 2 with the MFP 1, the user operates the input device 24 of the mobile terminal 2 and instructs activation of the cooperative application 22a. In addition, here, it is assumed that the mobile terminal 2 acquires the connection information to the MFP 1 by NFC and requests the MFP 1 connected via the network to print according to the connection information.

For example, when the user instructs acquisition of the connection information to the MFP 1 by NFC, the control unit 21 activates the cooperative application 22a (ACT 30). When the cooperative application 22a is activated, the control unit 21 sets the communication mode of non-contact communication by the non-contact communication device 27 to the card mode (ACT 31). When the non-contact communication device 27 is set in the card mode, the control unit 21 creates an electronic message in which the transmission request information for requesting connection information is set (ACT 32). For example, the control unit 21 creates an electronic message of a predetermined format in which the transmission request information for requesting connection information is set in the tag information.

Upon setting the electronic message in which the transmission request information is set, the non-contact communication device 27 transmits the electronic message according to the radio waves from the non-contact communication device 17 of the MFP 1 as a card reader (ACT 33). For example, when the user holds the mobile terminal 2 over the communication range E, the non-contact communication device 27 receives radio waves from the non-contact communication device 17 of the MFP 1 and transmits the electronic message. In this case, the control unit 21 may display a guide on the display device 23 to hold the mobile terminal 2 in the communication range E.

After the non-contact communication device 27 transmits the electronic message in which the transmission request information is set, the control unit 21 switches from the card mode to the reader mode. For example, the control unit 21 accepts an operation in which the user once separates the mobile terminal 2 from the communication range E and hold the mobile terminal 2 over the communication range E again. In this case, once the mobile terminal 2 is separated from the communication range E, the control unit 21 ends the non-contact communication by the non-contact communication device 27 in the card mode. When the mobile terminal 2 is again held in the communication range E after ending the card mode, the control unit 21 activates the non-contact communication device 27 in the reader mode (ACT 34). In this case, the control unit 21 may display a guide on the display device 23 to once separate the mobile terminal 2 from the communication range E and hold the mobile terminal 2 again. Through this operation, the control unit 21 switches the non-contact communication device 27 from the card mode to the reader mode. If the mobile terminal 2 autonomously switches the mode of non-contact communication, the control unit 21 may switch to the reader mode according to transmission of a response electronic message including transmission request information.

The non-contact communication device 27 that switched to the reader mode receives the electronic message in which the information requested in the transmission request information from the MFP 1 in the card mode is set (ACT 35). For example, when switching to the reader mode, the non-contact communication device 27 transmits radio waves requesting an electronic message and receives the electronic message from the MFP 1 in the card mode corresponding to the radio waves. In this case, the electronic message from the MFP 1 in the card mode includes information (for example, connection information) requested in the transmission request information set in the electronic message transmitted by the ACT 33.

When the non-contact communication device 27 in the reader mode receives the electronic message, the control unit 21 extracts the requested information from the received electronic message. For example, the control unit 21 extracts the connection information set in the tag information of the received electronic message. Upon receiving the electronic message including the requested information, the control unit 21 ends the reader mode of the non-contact communication device 27 (ACT 36).

Upon acquiring the connection information from the MFP 1 in the reader mode, the control unit 21 communicatively connects to the MFP 1 via the network by the communication unit 25 according to the acquired connection information (ACT 37). When communicatively connected to the MFP 1, the control unit 21 transmits a print request (print job) as a processing request to the MFP 1 via the communication unit 25 (ACT 38). For example, when communicatively connecting to the MFP 1, the control unit 21 accepts specification of print data by an input device operated by the user.

The processing that the mobile terminal 2 may request to the MFP 1 communicatively connected via the network is not limited to the print processing. For example, the mobile terminal 2 may request information such as image data read by the scanner 14 to the MFP 1 communicatively connected via the network. In this case, the mobile terminal 2 acquires the image data scanned by the MFP 1 by the scanner 14. In addition, the mobile terminal 2 may acquire information on state information (for example, an executable print mode, a usable paper size, and the like) from the MFP 1 with which communication is connected. Upon acquiring the state information from the MFP 1, the control unit 21 may display information indicating the state of the MFP 1 on the display device 23.

As described above, according to the present embodiment, the non-contact communication device (first NFC terminal) of the MFP in the reader mode reads information from the non-contact communication device (second NFC terminal) of the mobile terminal in the card mode in the communication range. The non-contact communication device of the MFP switches the operation mode to the card mode when the transmission request information for requesting specific information is set in the read information. The non-contact communication device of the MFP that is switched to the card mode transmits the information requested in the transmission request information to the non-contact communication device of the mobile terminal that is switched to the reader mode. Further, after transmitting the information in the card mode, the non-contact communication device of the MFP is autonomously switched to the reader mode.

In the embodiment, the non-contact communication device (first NFC terminal) of the MFP and the non-contact communication device (second NFC terminal) of the mobile terminal may exchange information by switching the operation mode. For example, even when the first NFC terminal waits in the reader mode and the second NFC terminal operates in the card mode, information may be transmitted from the first NFC terminal to the second NFC terminal.

In addition, if this embodiment is applied, the mobile terminal may acquire information from an information processing apparatus such as an MFP or the like by non-contact communication (NFC) by switching between the reader mode and card mode. For example, the mobile terminal may easily acquire connection information for transmitting print data (a print job) to the MFP by data communication other than non-contact communication from the MFP using NFC. In addition, the mobile terminal may also easily acquire status information indicating the state of the MFP from the MFP using NFC.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a non-contact communication device that performs non-contact communication in a reader mode or a card mode; and
a processor that:
determines whether or not transmission request information is set in an electronic message received from a second non-contact communication device while the noncontact communication device is executing the reader mode;
switches the non-contact communication device to the card mode when determining that the transmission request information is set in an electronic message;
sets information requested in the transmission request information in tag information of the electronic message output from the non-contact communication device in the card mode; and
causes the non-contact communication device that is switched to the card mode to transmit the electronic message in which information requested in the transmission request information is set to the second non-contact communication device and switches the non-contact communication device to the reader mode on condition that the electronic mail is transmitted to the second non-contact communication device.

2. The apparatus according to claim 1,
wherein the processor reactivates the non-contact communication device when determining that the transmission request information is set in the electronic message.

3. The apparatus according to claim 1,
wherein the processor reactivates the non-contact communication device on condition that the electronic message in which the information requested by the transmission request information is set is transmitted to the second non-contact communication device.

4. The apparatus according to claim 1,
wherein the processor further switches the non-contact communication device to the reader mode after transmitting the electronic message including the information requested in the transmission request information in the card mode.

5. The apparatus according to claim 1, further comprising:
a communication device that performs data communication through a communication method different from the non-contact communication by the non-contact communication device,
wherein the information requested in the transmission request information is connection information for performing the data communication with the communication device, and
the processor sets the connection information in the electronic message to be transmitted by the non-contact communication device that is switched to the card mode.

6. The apparatus according to claim 5, further comprising:
a printer that prints an image on a recording medium,
wherein the processor causes the printer to execute print processing in response to a print request from a device communicatively connected with the connection information.

7. The apparatus according to claim 1,
wherein the information requested by the transmission request information is state information indicating a state of the information processing apparatus, and
the processor sets the state information in the electronic message to be transmitted by the non-contact communication device that is switched to the card mode.

8. A non-transitory recording medium storing a program that causes a processor to:
operate a non-contact communication device mounted in a mobile terminal in a card mode;
determine whether or not transmission request information is set in an electronic message received from a second non-contact communication device while the noncontact communication device is executing the reader mode;
switch the non-contact communication device to the card mode when determining that the transmission request information is set in an electronic message;
set information requested in the transmission request information in tag information of the electronic message output from the non-contact communication device in the card mode; and
cause the non-contact communication device that is switched to the card mode to transmit the electronic message in which information requested in the transmission request information is set to the second non-contact communication device and switches the non-contact communication device to the reader mode on condition that the electronic mail is transmitted to the second non-contact communication device.

9. The non-transitory recording medium according to claim 8,
further causing the processor to:
reactivate the non-contact communication device when determining that the transmission request information is set in the electronic message.

10. The non-transitory recording medium according to claim 8,
further causing the processor to:
reactivate the non-contact communication device on condition that the electronic message in which the information requested by the transmission request information is set is transmitted to the second non-contact communication device.

11. The non-transitory recording medium according to claim 8,
wherein the transmission request information is information for requesting connection information to perform data communication with an information processing apparatus having a second non-contact communication device by a communication method different from non-contact communication by the non-contact communication device, and
the program further causes the processor to extract the connection information from the electronic message received by the non-contact communication device that is switched to the reader mode.

12. The non-transitory recording medium according to claim 11,
wherein the program further causes the processor to transmit a print request to an information processing apparatus having a printer communicatively connected with the connection information.

13. The non-transitory recording medium according to claim 8,
wherein the transmission request information is information for requesting state information indicating a state of an information processing apparatus having the second non-contact communication device that receives the electronic message to be transmitted by the non-contact communication device in the card mode, and
the program further causes the processor to extract the state information from the electronic message received by the non-contact communication device that is switched to the reader mode.

14. An information exchange method between a first non-contact communication device and a second non-contact communication device, the method comprising:
operating the first non-contact communication device in a reader mode;
determining whether or not transmission request information is set in an electronic message received from a second non-contact communication device while the noncontact communication device is executing the reader mode;
switching the non-contact communication device to the card mode when determining that the transmission request information is set in an electronic message;
setting information requested in the transmission request information in tag information of the electronic message output from the non-contact communication device in the card mode; and
causing the non-contact communication device that is switched to the card mode to transmit the electronic message in which information requested in the transmission request information is set to the second non-contact communication device and switches the non-contact communication device to the reader mode on condition that the electronic mail is transmitted to the second non-contact communication device.

15. The non-transitory recording medium according to claim 14, further comprising:
reactivating the non-contact communication device when determining that the transmission request information is set in the electronic message.

16. The non-transitory recording medium according to claim 14, further comprising:
reactivating the non-contact communication device on condition that the electronic message in which the information requested by the transmission request information is set is transmitted to the second non-contact communication device.
